(19) United States
(12) Patent Application Publication
(10) Pub. No.: US 2012/0221230 A1
(43) Pub. Date: Aug. 30, 2012

(54) METHOD AND SYSTEM FOR GENERATING AND SUPPLYING TRAFFIC-RELEVANT INFORMATION

(75) Inventors: Patrice Reilhac, Esslingen (DE); Adrien Charpentier, Stuttgart (DE); Julien Moizard, Paris (FR); Siav-Kuong Kuoch, Saint-Maur-des-Fosses (FR); Patrick Bonhoure, Annemasse (FR); Lowik Chanussot, Paris (FR)

(73) Assignee: VALEO SCHALTER UND SENSOREN GMBH, Bietigheim-Bissingen (DE)

(21) Appl. No.: 13/504,138

(22) PCT Filed: Oct. 27, 2010
(86) PCT No.: PCT/EP10/06544

§ 371 Date: Apr. 26, 2012

(30) Foreign Application Priority Data
Nov. 13, 2009 (DE) 10 2009 053 080.0

(51) Int. Cl. G08G 1/0968

(52) U.S. Cl. 701/117

(57) ABSTRACT

The invention relates to a method for generating and supplying traffic-relevant information, wherein each of a plurality of road users (10.1, 10.2) is provided with a mobile communications unit with which individual movement data (10.5) is wirelessly transmitted to a central processing system (20). The individual movement data (10.5) of the plurality of road users (10.1, 10.2) is collected and processed to location-specific and/or route-specific traffic-relevant information (30.1, 30.2), which relates to individual route sections or a road network (5). Upon request (10.7), the location-specific and/or route-specific traffic-relevant information (30.1, 30.2) is transmitted from the central processing system (20) to the mobile communications units. In order to increase and improve the information content of the traffic-relevant information that has been generated and supplied, the individual movement data (10.5) comprises traffic-relevant image information, which is processed to location-specific and/or route-specific traffic-relevant image information (30.1), by means of which a database (30) is generated and/or updated.

The invention relates to a method for producing and providing traffic-related information of the type cited in the preamble of claim 1 and to a corresponding system, a data processing program and a computer program product for carrying out the method for producing and providing traffic-related information.

Such a method for producing and providing traffic-related information is already known from DE 10 2006 052 319 A1. On the basis of the known method, a plurality of road users are each equipped with a mobile communication appliance which is used to transmit individual travel data wirelessly to a central computation installation. The individual travel data from the plurality of road users are collected and are processed to form location-oriented and/or road-oriented traffic-related information which relates to individual road sections in a traffic route network. In addition, the location-oriented and/or road-oriented traffic-related information is transmitted on request from the central computation installation to the mobile communication appliances.

It is an object of the invention to specify a method for producing and providing traffic-related information and a corresponding system, a data processing program and a computer program product for carrying out the method for producing and providing traffic-related information which increases and improves the information content of the traffic-related information produced and provided.

The invention achieves this object by means of a method for producing and providing traffic-related information having the features of claim 1, by means of a system for producing and providing traffic-related information having the features of claim 20, by means of a data processing program having the features of claim 26 and by means of a computer program product having the features of claim 27. Further features which advantageously refine the invention can be found in the subclaims.

The advantage attained with the invention is that the users are provided, by means of mobile communication appliances, with location-oriented and/or road-oriented traffic-related image information which advantageously increases and improves the information content of the traffic-related information produced and provided. In order to produce and provide the traffic-related information, a plurality of road users are each equipped with such a mobile communication appliance, which is used to transmit individual travel data wirelessly to a central computation installation. The transmitted individual travel data from the plurality of road users are collected and are processed to form location-oriented and/or road-oriented traffic-related information which relates to individual road sections in a traffic route network. The location-oriented and/or road-oriented traffic-related information is transmitted on request from the central computation installation to the mobile communication appliances. According to the invention, the individual travel data comprise traffic-related image information which is processed to form location-oriented and/or road-oriented traffic-related image information which is used to produce and/or update a database. By way of example, the traffic-related image information can be captured by an image recording device arranged in the mobile communication appliance and/or by image recording devices arranged in the vehicle and can be transmitted from the mobile communication appliance to the central computation installation via a transmission link which has been set up. The use of popular mobile communication appliances for capturing and transmitting traffic-related image data allows an advantageous increase and improvement in the information content of traffic reports, for example, since visual verification of traffic reports is possible. In addition, image evaluation algorithms can be used in order to identify a current traffic situation and/or current road and/or weather conditions in prescribed road sections in the traffic route network. The transmission of the individual travel data with traffic-related image information from the mobile communication appliances to the central computation installation is effected periodically, for example i.e. at regular intervals of time, and/or on the basis of a distance covered and/or under event control and/or on request. Furthermore, the mobile communication appliances, in contrast to static image recording devices, deliver traffic-related image information from a visual angle which corresponds to that of a driver rather than from an elevated visual angle. In addition, the use of mobile communication appliances allows traffic-related image information to be captured and collected from any locations within the traffic route network. Furthermore, three-dimensional views of the respective captured location in the traffic route network can be produced in the central computation installation from the traffic-related image information using known image evaluation algorithms. These three-dimensional views can then be used by driver assistance systems which, by way of example, comprise a parking space search function for finding free parking spaces and/or a navigation function. By way of example, the navigation function can use the three-dimensional views in order to present traffic nodes, such as confusing road junctions, using the ascertained route guidance, as a result of which it is advantageously made easier for the driver to select the correct lane, particularly for a turn-off maneuver. Furthermore, the three-dimensional views can also be used by the user for orientation purposes outside the vehicle. The essential advantage of the three-dimensional views described here is that they are produced from current image information and it is therefore possible for the instantaneous situation at the captured location to be output and to be presented three-dimensionally in each case.

The traffic-related image information can be extracted from the incoming individual travel data and can be conditioned, as a result of which only suitable image information is advantageously stored and collected in the database so as not to burden the central computation installation unnecessarily. Thus, by way of example, a plurality of pieces of image information collected for a prescribed location in the traffic route network can be assessed on the basis of prescribed criteria in order to produce a valid piece of location-oriented and/or road-oriented traffic-related image information for this prescribed location and to store it in the database. The prescribed criteria may comprise an image quality and/or a recording time and/or a presented image detail and/or a visual angle at which the image information or the image is captured. Furthermore, the location-oriented and/or road-oriented traffic-related image information can be converted to a standard format prior to storage in the database, as a result of which reproducible quality and/or transmission conditions can be made possible.

In one refinement of the method according to the invention, the locations in the traffic route network which have traffic-related image information collected for them can be prescribed on the basis of their strategic position and/or on the basis of the current and/or expected traffic situation and/or on the basis of calculated distances and/or on the basis of current positions of requesting communication appliances in the traffic route network, for example. By way of example the strategic position relates to important locations in the traffic route network, such as a traffic node, a road junction, etc. By way of example, the deemed initiating events for capturing and collecting image information may be traffic reports about queues that are forming and/or requests for route guidance, etc.

In a further refinement of the method according to the invention, the traffic-related image information and/or the location-oriented and/or road-oriented traffic-related image information can be evaluated in order to find prescribed image information parts. The prescribed image information parts may comprise a license plate and/or a road sign, for example. This advantageously allows sought vehicles in the traffic route network to be ascertained and/or the position of road signs, particularly for speed limiting, in the traffic route network to be identified and stored. The identified speed limits can be taken into account when calculating required travel times and can be output to the user as a piece of information about the maximum permitted speed. In the event of a hunt for a particular vehicle, a match between the prescribed image information part and a piece of traffic-related image information and/or a piece of location-oriented and/or road-oriented traffic-related image information allows a corresponding piece of location information to be ascertained and output to a requesting center.

In addition, the traffic-related image information and/or the location-oriented and/or road-oriented traffic-related image information can advantageously be evaluated in order to ascertain a current road condition and/or a current weather situation and/or a current traffic situation.

In a further refinement of the method according to the invention, the individual travel data comprise a starting location and/or a destination and/or a current speed and/or a current direction of travel and/or a current geographical position. The request transmitted from one of the mobile communication appliances to the central computation installation comprises, for example, the indication of a location in the traffic route network for which location-oriented and/or road-oriented traffic-related image information is requested. In response to such a request, the central computation installation transmits to the requesting mobile communication appliance location-oriented and/or road-oriented traffic-related image information from locations in the traffic route network which are situated within a prescribable radius of the indicated location in the traffic route network.

In addition or as an alternative, a request transmitted from one of the mobile communication appliances to the central computation installation may comprise the indication of a starting location and/or a destination in the traffic route network for which route guidance and location-oriented and/or road-oriented traffic-related image information are requested. In response to such a request, the central computation installation calculates route guidance for the transmitted starting location and the transmitted destination and transmits the route guidance to the requesting mobile communication appliance with corresponding location-oriented and/or road-oriented traffic-related image information from locations in the traffic route network which are part of the calculated route guidance. In addition, the request transmitted from one of the mobile communication appliances to the central computation installation may comprise a change to the calculated route guidance, wherein the central computation installation calculates, in response to the change request, new route guidance for the transmitted starting location and the transmitted destination and transmits it to the requesting mobile communication appliance with corresponding location-oriented and/or road-oriented traffic-related image information from locations in the traffic route network which are part of the recalculated route guidance.

In a further refinement of the method according to the invention, the request transmitted from one of the mobile communication appliances to the central computation installation may comprise the indication of a calculated route in the traffic route network for which location-oriented and/or road-oriented traffic related image information is requested. In response to such a request, the central computation installation transmits to the requesting mobile communication appliance, for the transmitted route, location-oriented and/or road-oriented traffic-related image information from locations in the traffic route network which are part of the transmitted route.

The central computation installation may advantageously output an alarm with associated location-oriented and/or road-oriented traffic-related image information to the corresponding mobile communication appliance if a traffic obstruction and/or a queue is identified at a location and/or on a route which relates to the transmitted requests.

These different embodiments allow the method according to the invention to be advantageously matched in optimum fashion to the conditions and equipment in the vehicle and to the mobile communication appliance used.

A system according to the invention for producing and providing traffic-related information, particularly for carrying out the method described, comprises a central computation installation which can be reached via a radio network and a plurality of road users which are each equipped with a mobile communication appliance which can be used to transmit individual travel data wirelessly to the central computation installation. The central computation installation collects the individual travel data from the plurality of road users and processes them to form location-oriented and/or road-oriented traffic-related information which relates to individual road sections in a traffic route network, wherein the central computation installation transmits the location-oriented and/or road-oriented traffic-related information on request to the mobile communication appliances. According to the invention, the central computation installation processes traffic-related image information which the individual travel data comprise to form location-oriented and/or road-oriented traffic-related image information and produces and/or updates a database with location-oriented and/or road-oriented traffic-related image information.

Advantageously, the mobile communication appliance may comprise different equipment variants and, by way of example, can use at least one image recording unit to capture traffic-related image information and/or can use at least one position-finding unit to ascertain a current geographic position and/or can use at least one navigation unit to ascertain a route between a starting location and a destination. Furthermore, the mobile communication appliance may be coupled to at least one vehicle system via a vehicle interface. The at least one image recording unit and/or the at least one position-finding unit and/or the at least one navigation unit may be arranged in the mobile communication appliance and/or in the vehicle.

The user can have the associated location-oriented and/or road-oriented traffic-related image information which is transmitted for a route displayed in an output panel, wherein the user can scroll the individual transmitted image information, for example using a pointer on a corresponding bar indicator which represents the route between the starting location and the destination, so that a piece of image information corresponding to the current position on the bar indicator is displayed in the output panel. Alternatively, the user can also move the pointer on a map presentation of the route between the starting location and the destination, wherein similarly the image information corresponding to the current position on the map presentation is displayed in the output panel. This allows the user to advantageously obtain visual information about the current traffic situations along the route before starting to travel. Furthermore, during the journey, the location-oriented and/or road-oriented traffic-related image information corresponding to the instantaneous geographical position of the mobile communication appliance can be displayed in the output panel automatically, with the instantaneous geographic position of the mobile communication appliance being displayed as a pointer in the bar indicator or in a map presentation.

Embodiments of the present invention can be implemented as a circuit, an apparatus, a method, a data processing program with program code means and/or as a computer program product. Accordingly, the present invention can be produced completely as hardware and/or as software and/or as a combination of hardware and/or software components. In addition, the present invention can be produced as a computer program product on a storage medium which can be used in computers and which has computer-readable program code, with different computer-readable storage media such as hard disks, CD-ROMs, optical or magnetic storage elements, etc., being able to be used.

Exemplary embodiments of the invention are explained in more detail below with reference to a graphical illustration. In the drawings, identical reference symbols denote components or elements which perform the same or similar functions.

In the illustration:

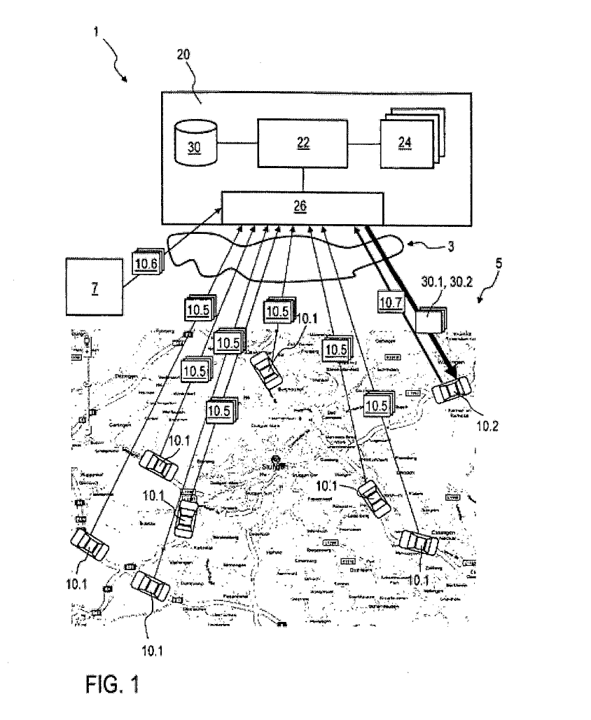

FIG. 1 shows a schematic illustration of an exemplary embodiment of a system according to the invention for producing and providing traffic-related information,

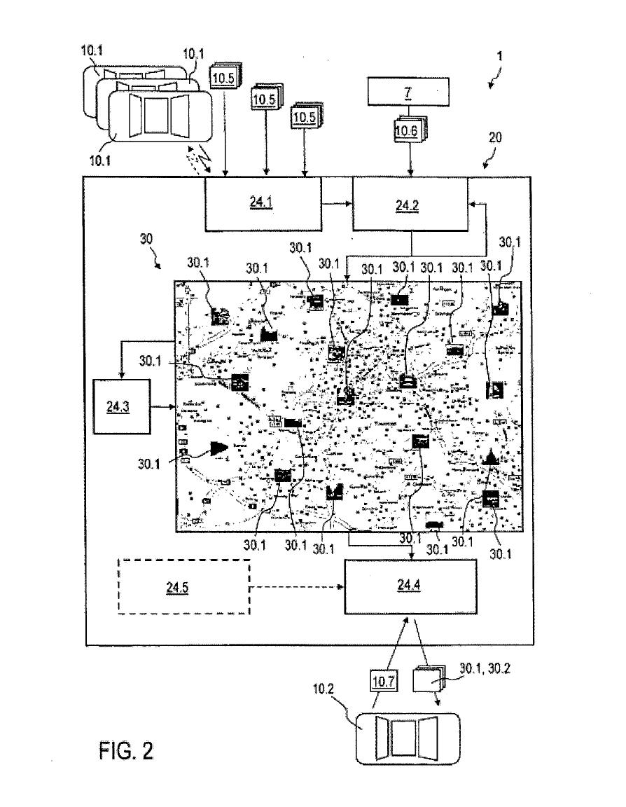

FIG. 2 shows a schematic block diagram to describe executable applications in a first exemplary embodiment of a central computation installation for the inventive system for producing and providing traffic-related information which is shown in FIG. 1,

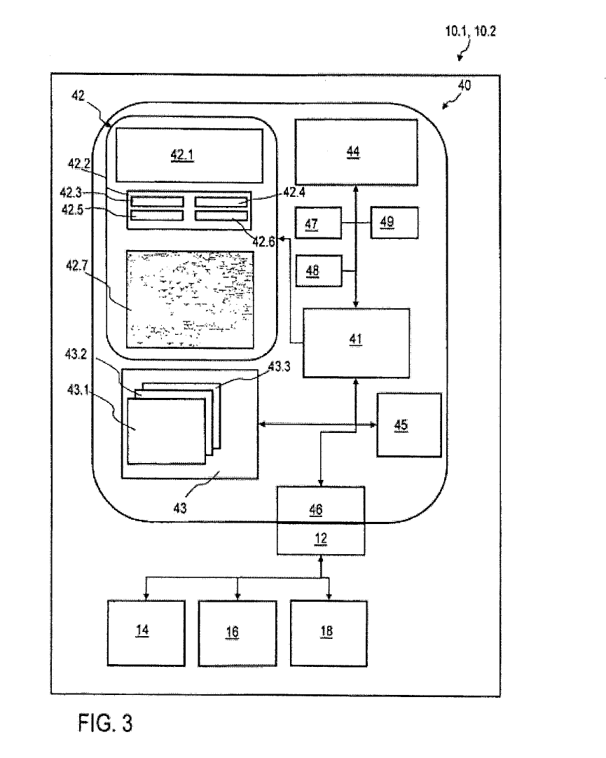

FIG. 3 shows a schematic block diagram of an exemplary embodiment of a vehicle with a mobile communication appliance for the system for producing and providing traffic-related information which is shown in FIG. 1,

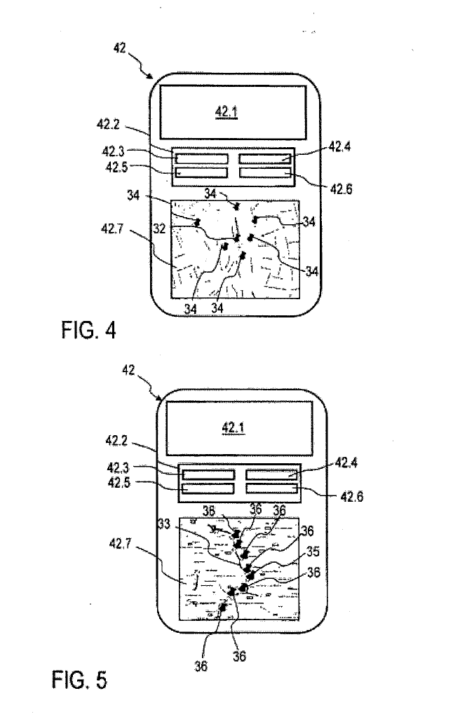

FIG. 4 shows a schematic block diagram of an exemplary embodiment of a visual display area of the mobile communication appliance from FIG. 3 in a first request mode,

FIG. 5 shows a schematic block diagram of an exemplary embodiment of the visual display area of the mobile communication appliance from FIG. 3 in a second request mode,

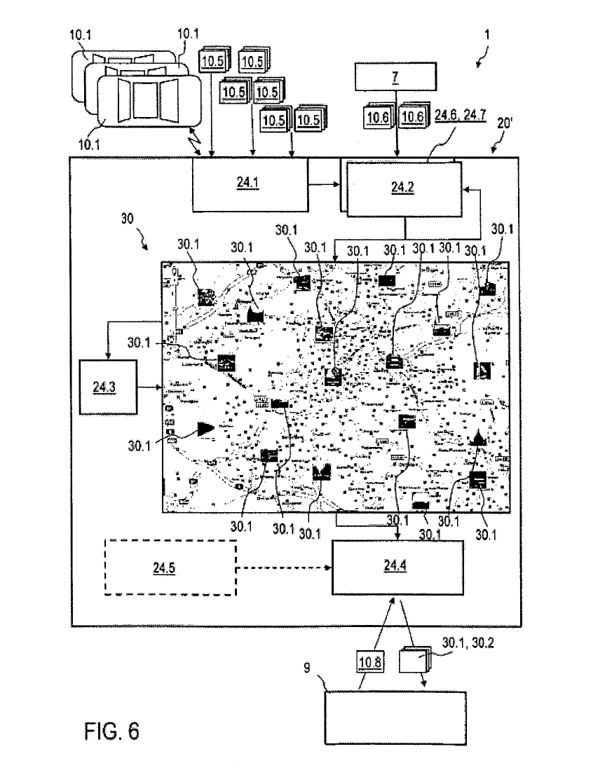

FIG. 6 shows a schematic block diagram to describe executable applications in a second exemplary embodiment of a central computation installation for the inventive system for producing and providing traffic-related information which is shown in FIG. 1,

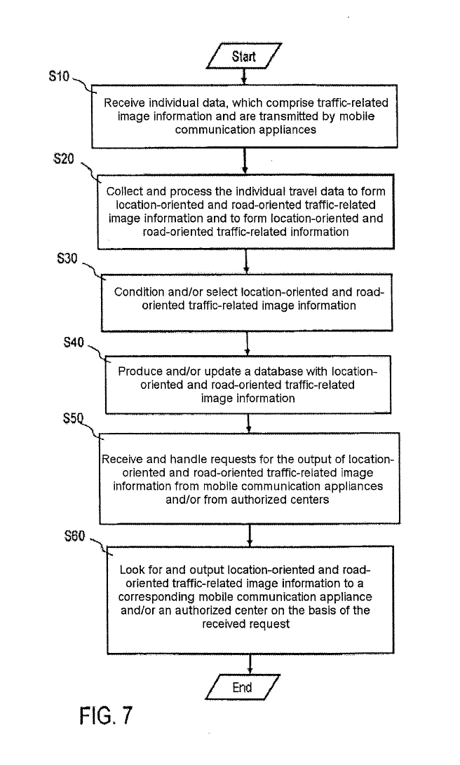

FIG. 7 shows a schematic flowchart of a first exemplary embodiment of a method according to the invention for producing and providing traffic-related information,

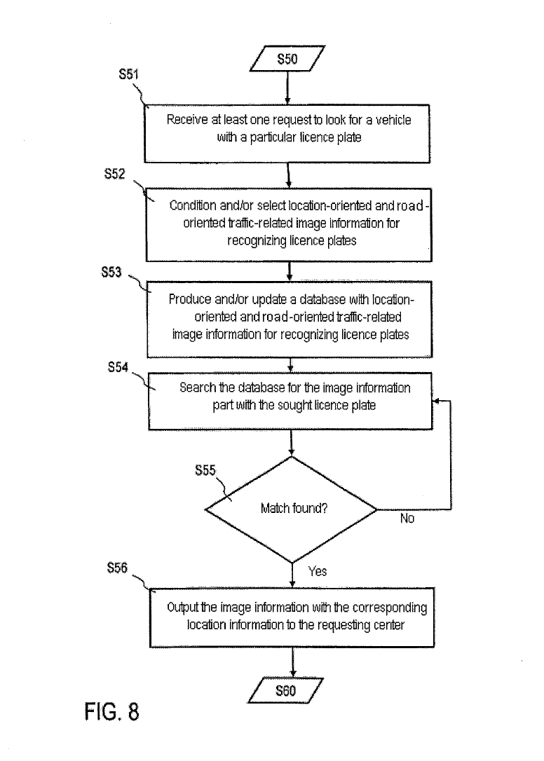

FIG. 8 shows a schematic flowchart of a second exemplary embodiment of a method according to the invention for producing and providing traffic-related information, and

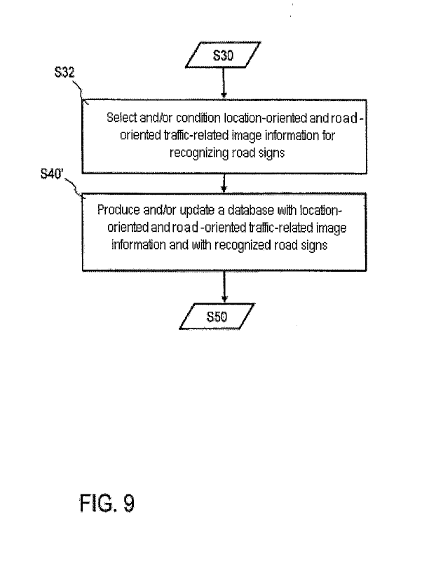

FIG. 9 shows a schematic flowchart of a third exemplary embodiment of a method according to the invention for producing and providing traffic-related information.

FIG. 1 shows a system 1 for producing and providing traffic-related information. As can be seen from FIG. 1, the system 1 for producing and providing traffic-related information comprises a central computation installation 20 which can be reached via a radio network 3 and a plurality of road users 10.1, 10.2 which are each equipped with a mobile communication appliance 40, which is shown in FIGS. 3 to 5. The mobile communication appliance 40 can be used to transmit individual travel data 10.5 from the road users 10.1, 10.2 wirelessly to the central computation installation 20. The central computation installation 20 collects the individual travel data 10.5 from the plurality of road users 10.1, 10.2 and processes the individual travel data 10.5 to form location-oriented and/or road-oriented traffic-related information 30.1, 30.2 which relates to individual road sections in a traffic route network 5, a detail from which is shown. On request 10.7, the central computation installation transmits the location-oriented and/or road-oriented traffic-related information 30.1, 30.2 to the mobile communication appliances 40. In the drawings, the road users 10.1, 10.2 firstly represent vehicles 10.1 with a mobile communication appliance 40, which act as a mobile information source, i.e. which provide individual travel data 10.5, and secondly represent vehicles 10.2 with a mobile communication appliance 40, which act as a mobile information sink, i.e. which request and receive location-oriented and/or road-oriented traffic-related information 30.1, 30.2.

According to the invention, the individual travel data 10.5 comprise traffic-related image information which is processed to form location-oriented and/or road-oriented traffic-related image information 30.1 which the central computation installation 20 uses to produce and/or update a database 30 with location-oriented and road-oriented traffic-related image information 30.1 in order to increase and improve the information content of the traffic-related information 30.1, 30.2 produced and provided. The transmission of the individual travel data 10.5 with traffic-related image information from the mobile communication appliances 40 to the central computation installation 20 is effected periodically, for example, i.e. at regular intervals of time, and/or on the basis of a distance covered and/or under event control and/or on request by the central computation installation 20.

As can also be seen from FIG. 1, the central computation installation 20 in the exemplary embodiment shown also receives traffic-related information 10.6 from a static traffic information source 7, such as from a traffic control center. This traffic-related information 10.6 may comprise queue information, traffic flow information, road condition information, weather information and/or image information from static image recording devices, for example. In order to produce and provide traffic-related information, the central computation installation 20 comprises a communication interface 26, which the central computation installation 20 uses to exchange information with the mobile communication appliances 40 and the static traffic information source 7 wirelessly and/or in wired fashion, and an evaluation and control unit 22, which executes a plurality of applications 24 and produces and/or updates the database 30 with location-oriented and/or road-oriented traffic-related image information 30.1.

FIG. 2 shows the central computation installation 20 for executing different applications 24.1, 24.2, 24.3, 24.4 and 24.5 according to a first exemplary embodiment. As can be seen from FIG. 2, the central computation installation 20 collects the individual travel data 10.5 from a plurality of vehicles 10.1 acting as an information source and collects the traffic-related information 10.6 from at least one static traffic information source 7. In a first application block 24.1, the central computation installation 20 selects and/or conditions and/or harmonizes the image information contained in the individual travel data 10.5. In a second application block 24.2, the central computation installation 20 takes the conditioned individual travel data 10.5 and the traffic-related information 10.6 and ascertains a current traffic situation in the traffic route network 5. In a third application block 24.3, the central computation installation 20 produces and updates at least one database 30 for location-oriented and/or road-oriented traffic-related image information 30.1, a detail from the database 30 being shown with location-oriented and/or road-oriented traffic-related image information 30.1. In a fourth application block 24.4, the central computation installation 20 handles requests 10.7 which are received from vehicles 10.2 acting as information sinks, one vehicle 10.2 from which is shown in the exemplary embodiment shown. On the basis of the received request 10.7, the central computation installation 20 looks for location-oriented and/or road-oriented traffic-related image information 30.1 and/or location-oriented and/or road-oriented traffic-related information 30.2 in the at least one database 30, selects relevant location-oriented and/or road-oriented traffic-related image information 30.1 and/or location-oriented and/or road-oriented traffic-related information 30.2 from that found and outputs it to the requesting vehicle 10.2. In a fifth application block 24.5, shown in dashes, the central computation installation 20 performs a navigation function as required and takes an input starting location and destination as a basis for calculating at least one route between the starting location and destination, takes further criteria, such as shortest route, fastest route, traffic situation, etc., as a basis for selecting a route and outputs said route to the requesting vehicle 10.2.

FIG. 3 shows a vehicle 10.1, 10.2 with a mobile communication appliance 40, and FIGS. 4 and 5 each show a request mode of the mobile communication appliance 40 from FIG. 3. As can be seen from FIGS. 3 to 5, the mobile communication appliance 40 comprises a further evaluation and control unit 41 for executing different applications 43.1, 43.2, 43.3 which are stored in a memory 43, a visual display area 42, an image recording unit 44 for capturing traffic-related image information, an operator control unit 45 with manual operator control elements, a vehicle interface 46 which the mobile communication appliance 40 can use to communicate with the vehicle 10.1, 10.2, a position-finding unit 47 for ascertaining a current geographic position, which is in the form of a GPS receiver, for example, a navigation unit 48, which comprises a gyroscope, for example, for ascertaining a route and for route guidance between a starting location and a destination, and a communication interface 49 for exchanging information with the central computation installation 20. The refinement described allows the mobile communication appliance 40, regardless of the equipment of the corresponding vehicle 10.1, 10.2, to execute the requisite applications, such as communication 43.1 with the central computation installation 20, capture 43.2 of traffic-related image information, output 43.3 of requested location-oriented and/or road-oriented image and/or traffic information 30.1, 30.2, etc., for the purpose of producing and providing traffic-related information.

As can also be seen from FIG. 3, the vehicle 10.1, 10.2 has a docking station 12 which can be used to couple the mobile communication appliance 40 to vehicle systems 14, 16, 18. The mobile communication appliance 40 is preferably arranged in the vehicle such that it can capture traffic-related image information through the windscreen. In the exemplary embodiment shown, the vehicle likewise has an image recording unit 14 for capturing traffic-related image information, a position-finding unit 16 for ascertaining a current geographical position, which is in the form of the GPS receiver, for example, and a navigation unit 18 for ascertaining a route and for route guidance between a starting location and a destination.

As can also be seen from FIGS. 3 to 5, the visual display area 42 comprises different display and/or output panels 42.1, 42.2, 42.7. A first display panel 42.1 can be used to present different status indicators for the executable applications 43.1, 43.2, 43.3, for example. An input mask 42.2 can be used to present different output panels 42.3, 42.5 for querying operator control information and corresponding input panels 42.4, 42.6 for inputting operator control information, in conjunction with the operator control unit 45 for controlling the executable applications 43.1, 43.2, 43.3. An output panel can be used to present a detail from the traffic route network 5 having requested traffic-related information.

As can also be seen from FIG. 4, the request 10.7 transmitted from the mobile communication appliance 40 to the central computation installation 20, in the first request mode, comprises the indication of a location 32 in the traffic route network 5 for which location-oriented and/or road-oriented traffic-related image information 30.1 is requested. By way of example, this prescribed location 32 may correspond to a current position of the mobile communication appliance 40. The central computation installation 20 transmits to the requesting mobile communication appliance 40 location-oriented and/or road-oriented traffic-related image information 30.1 from locations 34 in the traffic route network 5 which are situated within a prescribable radius of the indicated location 32 in the traffic route network 5. The locations 34 for which location-oriented and/or road-oriented traffic-related image information 30.1 is available are output on the output area 42.7 and can be selected by the user using the operator control unit in order to output the corresponding location-oriented and/or road-oriented traffic-related image information 30.1 on the output area 42.7.

As can also be seen from FIG. 5, the request 10.7 transmitted from the mobile communication appliance 40 to the central computation installation 20, in the second request mode, comprises the indication of a starting location and a destination for calculating a route 33 or comprises an already calculated route 33 between a starting location and a destination location 32 in the traffic route network 5 for which location-oriented and/or road-oriented traffic-related image information 30.1 is requested. The central computation installation 20 transmits to the requesting mobile communication appliance 40 location-oriented and/or road-oriented traffic-related image information 30.1 from locations 36 in the traffic route network 5 which are situated within a prescribable radius of the current position 35 of the mobile communication appliance 40 in the traffic route network 5 and are part of the route 33. Those locations 36 on the route 33 for which location-oriented and/or road-oriented traffic-related image information 30.1 is available are output on the output area 42.7 and can be selected by the user using the operator control unit in order to output the corresponding location-oriented and/or road-oriented traffic-related image information 30.1 on the output area 42.7. If the user wishes to alter the calculated route 33 on the basis of the current traffic situation, the request 10.7 transmitted from one of the mobile communication appliances 40 to the central computation installation 20 comprises a change to the calculated route guidance 33. In response to the change request, the central computation installation 20 calculates a new route guidance for the transmitted starting location and the transmitted destination and transmits the new route guidance to the requesting mobile communication appliance 40 with corresponding location-oriented and/or road-oriented traffic-related image information 30.1 from locations 36 in the traffic route network 5 which are part of the recalculated route guidance.

Alternatively, the request 10.7 transmitted from one of the mobile communication appliances 40 to the central computation installation 20 may comprise the indication of a calculated route in the traffic route network 5 for which location-oriented and/or road-oriented traffic-related image information 30.1 is requested if the requesting mobile communication appliance 40 or the vehicle 10.1, 10.2 has a dedicated navigation unit 18, 48. In this embodiment, the central computation installation 20 transmits to the requesting mobile communication appliance 40 the location-oriented and/or road-oriented traffic-related image information 30.1 from locations 36 in the traffic route network 5 which are situated on the transmitted route.

In order to warn the users, the central computation installation 20 transmits an alarm with associated location-oriented and/or road-oriented traffic-related image information 30.1 to the corresponding mobile communication appliances 40 if a traffic obstruction and/or a queue is identified at a location 32, 34, 35, 36 and/or on a route 33 which relate to the transmitted requests 10.7.

FIG. 6 shows the central computation installation 20′ for executing different applications 24.1, 24.2, 24.3, 24.4. 24.5, 24.6 and 24.7 according to a second exemplary embodiment. The second exemplary embodiment of the central computation installation 20′ corresponds essentially to the first exemplary embodiment shown in FIG. 2 and, in contrast to the first exemplary embodiment, also executes two further applications 24.6, 24.7 in addition to the applications 24.1 to 24.5 described therein. On the basis of the further application 24.6, the central computation installation 20′, on request by an authorized center 9, such as a police station, performs image evaluation with the transmitted traffic-related image information and/or the location-oriented and/or road-oriented traffic-related image information 30.1 stored in the database 30 in order to find prescribed image information parts which relate to license plates of sought vehicles in the traffic route network 5. In the event of a match between the prescribed image information part and a piece of traffic-related image information and/or a piece of location-oriented and/or road-oriented traffic-related image information 30.1, a corresponding piece of location information is ascertained and is output to the requesting center 9. As a result, the hunt for sought vehicles can advantageously be rendered more effective.

When such a search request has been made, the transmission rate of the individual travel data 10.5 with traffic-related image information from the mobile communication appliances 40 to the central computation installation 20 can be increased. In the exemplary embodiment shown, the transmission rate of the individual travel data 10.5 has been doubled, which is indicated by the illustration of two respective data packets. Furthermore, the transmission rate of the traffic-related information 10.6, which comprises image information from static image recording devices, from the static traffic information source 7 has also been doubled.

On the basis of the further application 24.7, the central computation installation 20′ performs image evaluation with the transmitted traffic-related image information and/or the location-oriented and/or road-oriented traffic-related image information 30.1 stored in the database 30 in order to ascertain a current road condition and/or a current weather situation and/or a current traffic situation and/or to identify road signs. Preferably, road signs relating to speed limits in the traffic route network 5 are captured and are stored in the database 30 on a location-oriented basis. The speed indications ascertained and stored in this manner can be taken into account when calculating required travel times and can be output to the user as information about the maximum permitted speed.

FIG. 7 shows a first exemplary embodiment of a method according to the invention for producing and providing traffic-related information. As can be seen from FIG. 7, following the initialization of the method for producing and providing traffic-related information, a first step S10 involves individual travel data with traffic-related image information being received which are transmitted from mobile communication appliances 40. In a step S20, the individual travel data 10.5 are collected and are processed to form location-oriented and/or road-oriented traffic-related image data 30.1 and to form location-oriented and/or road-oriented traffic-related information 30.2. In a step S30, the location-oriented and/or road-oriented traffic-related image information 30.1 is conditioned and/or selected. In a step S40, the location-oriented and/or road-oriented traffic-related image information 30.1 is used to produce and/or update a database 30. In a step S50, requests for the output of location-oriented and/or road-oriented traffic-related image information 30.1 are received from mobile communication appliances 40 and/or from authorized centers and are handled. In a step S60, the received request is taken as a basis for looking for location-oriented and/or road-oriented traffic-related image information 30.1 and outputting it to the corresponding mobile communication appliance 40 and/or an authorized center 9.

FIG. 8 shows a second exemplary embodiment of a method according to the invention for producing and providing traffic-related information. As can be seen from FIG. 8, steps S51 to S56 have been inserted between step S50 and step S60 in the second exemplary embodiment shown. In step S51, at least one request to look for a vehicle with a particular license plate is received from an authorized center 9. In response to such a request, a step S52 involves the location-oriented and/or road-oriented traffic-related image information 30.1 for identifying license plates being conditioned and selected. In step S53, a database is produced and/or updated with location-oriented and/or road-oriented traffic-related image information 30.1 for identifying license plates. In a step S54, the location-oriented and/or road-oriented traffic-related image information 30.1 in the database is searched for the sought image information part, i.e. for the sought license plate. If the test S55 involves a matching being found, step S56 involves the image information 30.1 being output with the corresponding location information 30.2 to the requesting center 9. If no match is found, the search as per step S54 is continued.

FIG. 9 shows a third exemplary embodiment of a method according to the invention for producing and providing traffic-related information. As can be seen from FIG. 9, step S32 has been inserted between step S30 and step S40 in the third exemplary embodiment shown, and step S40′ is carried out instead of step S40. In a step S32, location-oriented and/or road-oriented traffic-related image information 30.1 for identifying road signs is selected and conditioned. In step 40′, a database 30 is produced and/or updated with location-oriented and/or road-oriented traffic-related image information 30.1 and with identified road signs.

When the traffic-related image information is extracted and/or conditioned from the incoming individual travel data 10.5, a plurality of pieces of image information collected for a prescribed location 32 in the traffic route network 5 can be assessed on the basis of prescribed criteria in order to produce a valid piece of location-oriented and/or road-oriented traffic-related image information 30.1 for this prescribed location 32 and to store it in the database 30. By way of example, the prescribed criteria comprise image quality and/or recording time and/or presented image detail and/or visual angle. These criteria can be varied on the basis of the executed application 24, since other areas of the captured image information are important for identifying license plates and the road condition than for identifying road signs. In order to simplify the handling and transmission of the location-oriented and/or road-oriented traffic-related image information 30.1, the location-oriented and/or road-oriented traffic-related image information 30.1 can be converted to a standard format prior to storage in the database 30. Those locations 32, 34 in the traffic route network 5 for which location-oriented and/or road-oriented traffic-related image information 30.1 is collected can be prescribed in the traffic route network 5 on the basis of their strategic position and/or on the basis of the current and/or expected traffic situation and/or on the basis of calculated distances 33 and/or on the basis of current locations 32 using requesting communication appliances 40. Furthermore, the location-oriented and/or road-oriented traffic-related image information 30.1 can be evaluated in order to ascertain a current road condition and/or a current weather situation and/or a current traffic situation. In addition, the individual travel data 10.5 may comprise a starting location and/or a destination and/or a current speed and/or a current direction of travel and/or a current geographic position 35.

In order to implement the method according to the invention for producing and providing traffic-related information, it is also possible for a plurality of computers or computation units in the central computation unit or for a plurality of central computation units to be networked to one another.

Embodiments of the present invention can be implemented as a circuit, an apparatus, a method, a data processing program with program code means and/or as a computer program product. Accordingly, the present invention can be produced completely as hardware and/or as software and/or as a combination of hardware and/or software components. In addition, the present invention can be produced as a computer program product on a storage medium which can be used in computers and which has computer-readable program code, with different computer-readable storage media such as hard disks, CD-ROMs, optical or magnetic storage elements, etc., being able to be used.

The media which can be used in computers, or computer-readable media, may comprise electronic, magnetic, optical, electromagnetic infrared or semiconductor systems, apparatuses, appliances or distribution media, for example. In addition, the computer-readable media may comprise an electrical connection by means of one or more lines, a portable computer floppy disk, a random access memory (RAM), a read only memory (ROM), an erasable programmable read only memory (EPROM or flash memory), an optical line and a portable CD-ROM. The medium which can be used in computers, or the computer-readable medium, may even be paper or another suitable medium on which the program has been written and from which it can be captured electrically, for example by means an optical scanning operation on the paper or on the other medium, then compiled, interpreted or, if necessary, processed in another way and then stored in the computer memory.

1. A method for producing and providing traffic-related information, wherein a plurality of road users are each equipped with a mobile communication appliance, the method comprising:
wirelessly transmitting, using the mobile communication appliance of each road user, individual travel data to a central computation installation;
collecting and processing the individual travel data from the plurality of road users to form location-oriented and/or road-oriented traffic-related information which relates to individual road sections of a traffic route network; and
transmitting the location-oriented and/or road-oriented traffic-related information on a request from the central computation installation to the mobile communication appliances; and
processing the individual travel data comprising traffic-related image information to form location-oriented and/or road-oriented traffic-related image information which is used to produce and update a database,
wherein the traffic-related image information, the location-oriented and road-oriented traffic-related image information is evaluated in order to find prescribed image information parts.

2. The method as claimed in claim 1, wherein the prescribed image information parts comprise a license plate and/or a road sign.

3. The method as claimed in claim 2, wherein, in the event of a match between the prescribed image information part and a piece of traffic-related image information and/or a piece of location-oriented and/or road-oriented traffic-related image information, a corresponding piece of location information is ascertained and is output to a requesting center.

4. The method as claimed in claim 1, wherein the traffic-related image information is extracted from the incoming individual travel data and is conditioned.

5. The method as claimed in claim 1, wherein a plurality of pieces of image information collected for a prescribed location in the traffic route network are assessed on the basis of prescribed criteria in order to produce a valid piece of location-oriented and/or road-oriented traffic-related image information for the prescribed location and to store the valid piece of location-oriented and/or road-oriented traffic-related image information in the database.

6. The method as claimed in claim 5, wherein the prescribed criteria comprise an image quality and/or a recording time and/or a presented image detail and/or a visual angle.

7. The method as claimed in claim 5, wherein the location-oriented and/or road-oriented traffic-related image information is converted to a standard format prior to storage in the database.

8. The method as claimed in claim 5, wherein the locations in the traffic route network which have traffic-related image information collected for them are prescribed on the basis of at least one selected from a group consisting of their strategic position, a current and/or expected traffic situation, calculated routes, and current positions requesting communication appliances in the traffic route network.

9. The method as claimed in claim 1, wherein the traffic-related image information and/or the location-oriented and/or road-oriented traffic-related image information is evaluated in order to ascertain a current road condition, a current weather situation, or a current traffic situation.

10. The method as claimed in claim 1, wherein the individual travel data comprise at least one selected from a group consisting of a starting location, a destination, a current speed, a current direction of travel, and a current geographical position.

11. The method as claimed in claim 1, wherein the request transmitted from one of the mobile communication appliances to the central computation installation comprises the indication of a location in the traffic route network for which location-oriented and/or road-oriented traffic-related image information is requested.

12. The method as claimed in claim 11, wherein the central computation installation transmits to the requesting mobile communication appliance location-oriented and/or road-oriented traffic-related image information from locations in the traffic route network which are situated within a prescribable radius of the indicated location in the traffic route network.

13. The method as claimed in claim 1, wherein the request transmitted from one of the mobile communication appliances to the central computation installation comprises the indication of a starting location and/or of a destination in the traffic route network for which route guidance and location-oriented and/or road-oriented traffic-related image information are requested.

14. The method as claimed in claim 13, wherein the central computation installation calculates route guidance for the transmitted starting location and the transmitted destination and transmits it to the requesting mobile communication appliance with corresponding location-oriented and/or road-oriented traffic-related image information from locations in the traffic route network which are part of the calculated route guidance.

15. The method as claimed in claim 14, wherein the request transmitted from one of the mobile communication appliances to the central computation installation comprises a change to the calculated route guidance, wherein the central computation installation calculates, in response to the change request, new route guidance for the transmitted starting location and the transmitted destination and transmits it to the requesting mobile communication appliance with corresponding location-oriented and/or road-oriented traffic-related image information from locations in the traffic route network which are part of the recalculated route guidance.

16. The method as claimed in claim 1, wherein the request transmitted from one of the mobile communication appliances to the central computation installation comprises the indication of a calculated route in the traffic route network for which location-oriented and/or road-oriented traffic-related image information is requested.

17. The method as claimed in claim 16, the central computation installation transmits to the requesting mobile communication appliance, for a transmitted route, location-oriented and/or road-oriented traffic-related image information from locations in the traffic route network which are part of the transmitted route.

18. The method as claimed in claim 11, wherein the central computation installation outputs an alarm with associated location-oriented and/or road-oriented traffic-related image information to the corresponding mobile communication appliance if a traffic obstruction and/or a queue is identified at a location or on a route which relates to the transmitted request.

19. A system for producing and providing traffic-related information, for carrying out the method as claimed in claim 1, the system comprising:
a central computation installation which can be reached via a radio network; and
a plurality of road users which are each equipped with a mobile communication appliance used to transmit individual travel data wirelessly to the central computation installation,
wherein the central computation installation collects the individual travel data from the plurality of road users and processes the data to form location-oriented and/or road-oriented traffic-related information which relates to individual road sections from a traffic route network,
wherein the central computation installation transmits the location-oriented and/or road-oriented traffic-related information on request to the mobile communication appliances, and
wherein the central computation installation processes traffic-related image information which is part of the individual travel data to form location-oriented and/or road-oriented traffic-related image information and produces and/or updates a database with location-oriented and road-oriented traffic-related image information.

20. The system as claimed in claim 19, wherein the mobile communication appliance captures traffic-related image information by using at least one image recording unit.

21. The system as claimed in claim 20, wherein the mobile communication appliance ascertains a current geographical position by using at least one position-finding unit.

22. The system as claimed in claim 21, wherein the mobile communication appliance ascertains a route between a starting location and a destination by using at least one navigation unit.

23. The system as claimed in claim 19, wherein the mobile communication appliance is coupled to at least one vehicle system via a vehicle interface.

24. The system as claimed in claim 22, wherein the at least one image recording unit, the at least one position-finding unit, and/or the at least one navigation unit are arranged in the mobile communication appliance and/or in the vehicle.

25. A data processing program having program code instructions for performing of the method as claimed in claim 1 by a data processing system when the program is executed by the data processing system.

26. A computer program product having program code instructions which are stored in a computer-readable medium in order to carry out the method as claimed in claim 1 when the computer program product is executed on a computer.
